(19) United States
(12) Patent Application Publication
(10) Pub. No.: US 2009/0234569 A1
(43) Pub. Date: Sep. 17, 2009

(54) Routing Method For Calculating A Route

(76) Inventors: Ralph Jansen, Marktbreit (DE); Harald Kortge, Wurzburg (DE)

Correspondence Address: QUARLES & BRADY LLP, 411 E. WISCONSIN AVENUE, SUITE 2040, MILWAUKEE, WI, 53202-4497, US

(21) Appl. No.: 12/400,657

(22) Filed: Mar. 9, 2009

(30) Foreign Application Priority Data
Mar. 11, 2008 (DE) 10 2008 013 636.0
Jun. 12, 2008 (DE) 10 2008 027 957.9

(51) Int. Cl. G01C 21/36; G06F 17/30

(52) U.S. Cl. 701/200; 707/104.1; 707/102; 707/E17.005; 707/E17.018; 707/E17.044

(57) ABSTRACT

A routing method for calculating a route between a first route endpoint (03), particularly a starting point, and a second route endpoint (04), particularly a destination, utilizes an electronically stored road map. The method includes the following steps:
a) defining a starting point (03) on a tile (02a);
b) calculating the travel cost value for all routes from the starting point (03) to all boundary elements (06) of the tile (02a) with a route calculation module, wherein the travel costs between the starting point (03) and each boundary element (06) are exactly determined during the travel cost calculation;
c) calculating a travel cost estimation for all boundary elements (06) of the tile (02a) with a distance evaluation module, wherein the travel costs from a boundary element (06) of the tile (02a) to one of the two route endpoints (04) are evaluated in an estimative fashion during the travel cost estimation based on the distance between the boundary element (06) and the route endpoint (04);
d) determining a combined value for all boundary elements (06) of the tile (02a) in a combined evaluation module, wherein the exactly calculated travel costs within the tile (02a) and the estimated travel costs outside the tile (02b) are evaluated in a combined fashion during the combined evaluation;
e) determining the next tile (02b) for continuing the route calculation in dependence on the combined evaluation; and
f) repeating steps a) to e) until an abort condition is fulfilled.

### CROSS-REFERENCE TO RELATED APPLICATIONS

This application claims the priority benefit of German Patent Application No. 10 2008 013 636.0 filed on Mar. 11, 2008 and German Patent Application No. 10 2008 027 957.9 filed on Jun. 12, 2008, the contents of which are hereby incorporated by reference as if fully set forth herein in their entirety.

### STATEMENT CONCERNING FEDERALLY SPONSORED RESEARCH OR DEVELOPMENT

Not applicable.

### FIELD OF THE INVENTION

The invention pertains to a routing method for calculating a route between a first route endpoint, particularly a starting point, and a second route endpoint, particularly a destination.

### BACKGROUND OF THE INVENTION

Routing methods of the generic type are used in the operation of navigation systems in order to calculate a route between two route endpoints. The route endpoints may consist, in particular, of the starting point and the destination of a driving route planned by a driver of a motor vehicle.

The basis of any routing method realized on an electronic assistance system, particularly a navigation device, is an electronically stored road map that describes the road network of a certain geographic area that consists of roads and intersections in electronically readable form and is stored in a database for this purpose. In order to simplify the management of the data for describing the electronic road map, it is known to divide the road map into several sections that are generally referred to as tiles below. The tiles that are stored in the database in the form of individual groups of datasets collectively form the complete road map. Since each tile may be relatively small in comparison with the entire geographic area, the selective processing of the groups of datasets assigned to the tiles makes it possible to realize fast processing methods that only utilize very limited system resources. An electronically stored road map that is divided into individual tiles is described, for example, in DE 199 57 469 A1.

The road map that is divided into individual tiles is characterized in that boundary lines exist between adjacent tiles. On these boundary lines, the road map continuously merges in boundary elements, particularly boundary roads, boundary intersections and/or boundary points.

In conventional routing methods, the route calculation begins at a route endpoint and the calculation front realized with the routing algorithm propagates around this route endpoint similar to a circular wave. In other words, routing methods known so far search for route alternatives in all directions with the same speed without taking into account the relative position of the second route endpoint in relation to the first route endpoint. As soon as the circular calculation front has reached the second route endpoint, the routing method is aborted because at least one possible route has been found.

These conventional route calculation algorithms can also be used in connection with an electronic road map that is divided into tiles. The route calculation front in the form of a circular wave propagates over the road map divided into tiles from the first tile, in which the first route endpoint is situated, wherein the route calculation always crosses over from one tile to the next tile at the boundary elements on the boundary lines between the individual tiles.

The disadvantage of known routing methods is that a plurality of calculation steps needs to be carried out although it is foreseeable that the calculation does not pertain to very promising variations for finding a route. This is particularly disadvantageous in instances, in which very long routes need to be calculated. For example, if a route should be calculated from the North Cape to Gibraltar, conventional route calculation algorithms make it necessary to process a calculation front that propagates around the North Cape in the form of a circular wave until the calculation front has passed over the second route endpoint in Gibraltar. In this case, a plurality of tiles of the road map needs to be calculated although it is apparent that these alternatives will not result in a usable route. Consequently, known route calculation methods result in very long and therefore objectionable route calculation times, particularly when calculating very long routes.

### SUMMARY OF THE INVENTION

Based on this prior art, the present invention therefore aims to propose a new routing method for calculating a route that eliminates the disadvantages of the prior art. This objective is attained with a navigation device having a central processing unit that calculates a route between route endpoints in accordance with a routing method incorporating the present invention.

One embodiment of a routing method incorporating the present invention includes calculating a route between a first route endpoint, particularly a starting point, and a second route endpoint, particularly a destination, by utilizing an electronically stored road map that describes the road network of a certain geographic area consisting of roads and intersections by means of datasets stored in a database, wherein the road map is divided into several sections, namely tiles, that are stored in the database in the form of individual groups of datasets, wherein the tiles collectively form the complete road map, and wherein the road network merges in boundary elements particularly boundary roads, boundary intersections and/or boundary points, on the boundary lines between adjacent tiles. The method includes the following steps:
a) defining a starting point on a tile;
b) calculating the travel cost value for all routes from the starting point to all boundary elements of the tile with a route calculation module, wherein the travel costs between the starting point and each boundary element are exactly determined during the travel cost calculation;
c) calculating a travel cost estimation for all boundary elements of the tile with a distance evaluation module, wherein the travel costs from a boundary element of the tile to one of the two route endpoints are evaluated in an estimative fashion during the travel cost estimation based on the distance between the boundary element and the route endpoint;
d) determining a combined value for all boundary elements of the tile in a combined evaluation module, wherein the exactly calculated travel costs within the tile and the estimated travel costs outside the tile are evaluated in a combined fashion during the combined evaluation;
e) determining the next tile for continuing the route calculation in dependence on the combined evaluation; and
f) repeating steps a) to e) until an abort condition is fulfilled.

Different aspects of the inventive method are schematically illustrated in the drawings and described in an exemplary fashion below.

### BRIEF DESCRIPTION OF THE DRAWINGS

In these drawings:

FIG. 1 shows a top view of a geographic area with the corresponding road network that is divided into several tiles;

FIG. 2 shows the road network according to FIG. 1 after carrying out the exact travel cost calculation in a first tile;

FIG. 3 shows the road network according to FIG. 2 after carrying out the travel cost estimation; and

FIG. 4 shows the road network according to FIG. 3 after determining the tile for the next calculation step.

### DETAILED DESCRIPTION OF THE EXAMPLE EMBODIMENTS

One embodiment of a routing method incorporating the present invention includes calculating a route between a first route endpoint, particularly a starting point, and a second route endpoint, particularly a destination, by utilizing an electronically stored road map that describes the road network of a certain geographic area consisting of roads and intersections by means of datasets stored in a database, wherein the road map is divided into several sections, namely tiles, that are stored in the database in the form of individual groups of datasets, wherein the tiles collectively form the complete road map, and wherein the road network merges in boundary elements particularly boundary roads, boundary intersections and/or boundary points, on the boundary lines between adjacent tiles. The method includes the following steps:
a) defining a starting point on a tile;
b) calculating the travel cost value for all routes from the starting point to all boundary elements of the tile with a route calculation module, wherein the travel costs between the starting point and each boundary element are exactly determined during the travel cost calculation;
c) calculating a travel cost estimation for all boundary elements of the tile with a distance evaluation module, wherein the travel costs from a boundary element of the tile to one of the two route endpoints are evaluated in an estimative fashion during the travel cost estimation based on the distance between the boundary element and the route endpoint;
d) determining a combined value for all boundary elements of the tile in a combined evaluation module, wherein the exactly calculated travel costs within the tile and the estimated travel costs outside the tile are evaluated in a combined fashion during the combined evaluation;
e) determining the next tile for continuing the route calculation in dependence on the combined evaluation; and
f) repeating steps a) to e) until an abort condition is fulfilled.

The inventive routing method is based on the fundamental idea that the search for a suitable route is more promising in certain directions than in other directions. For example, if the second route endpoint is located exactly to the south of the first route endpoint, a search for a route in the northerly direction is not very promising while there is a relatively high probability that a search for a route in the southerly direction will lead to a suitable result.

In the inventive method, this fundamental idea is linked with the fact that an electronically stored road map divided into individual tiles is used for the calculation.

In the inventive method, a starting point is initially selected from a tile in a calculation step. At the beginning of the actual route calculation method, the starting point will usually consist of one of the two route endpoints. Based on this starting point, the travel cost value for all routes from the starting point to all boundary elements of the tile is then calculated with a route calculation module. In the calculation of the travel costs within the tile, the travel costs between the starting point and each boundary element are exactly determined in this case. In other words, this means that a calculation front that propagates in the form of a circular wave is generated within the tile and the calculation is not aborted until the calculation front has covered all boundary elements of the tile.

In a second step, a travel cost estimation is then carried out for all boundary elements of the tile by means of a distance evaluation module. In the travel cost estimation, the travel costs from each boundary element of the tile to one of the two route endpoints are evaluated in an estimative fashion based on the distance between the boundary element and the route endpoint. With respect to the calculation, this travel cost estimation is much simpler than the exact travel cost calculation because the estimation can be carried out, for example, solely on the basis of a straight line between the boundary element and the route endpoint.

Consequently, the route calculation module carries out an exact travel cost evaluation within the tile while the distance evaluation module merely carries out a travel cost estimation for the distance outside the tile. These two partial results are then jointly evaluated in a third step in a combined evaluation module. This results in a combined evaluation for each boundary element of the respective tile in question, wherein this combined evaluation is based on the exactly calculated travel costs within the tile, as well as on the estimated travel costs outside the tile. In the next step, the directly adjacent tile, in which the route calculation is continued, is then determined in dependence on the combined evaluations of the individual boundary elements. In this case, the tile that shares the boundary element with the best combined evaluation with the currently calculated tile usually is at least included in the tiles selected for the continuation of the route calculation method.

Subsequently, the calculation steps are repeated for the next tile until one abort condition is totally fulfilled, for example, at least one route between the two route endpoints has been determined. The utilization of the inventive method makes it possible for the calculation front of the route algorithm to propagate in the preferred direction. In this case, the preferred direction of the route calculation front results, in particular, from the travel cost estimation that is carried out in the distance evaluation module and is incorporated into the combined evaluation by means of the combined evaluation module.

It is usually sensible to calculate the entire route with the inventive routing method, wherein a first route endpoint needs to be set as starting point at the beginning of the route calculation in step a) in this case.

When calculating the entire route with the inventive method, the abort condition in step f) furthermore is only fulfilled once at least one route between the two route endpoints has been determined.

The inventive method is based, in essence, on the combined evaluation of the exactly calculated travel costs within the tile and the merely estimated travel costs outside the tile. In this case, it is obvious that different results are obtained in dependence of the weighting of the two partial results in the combined evaluation. For example, if the exact travel cost calculation within the tile is very heavily weighted in the combined evaluation and the travel cost estimation outside the tile is only lightly weighted, the obtained calculation results correspond to the circular propagation of the calculation front in conventional route calculation methods. However, if the travel cost estimation outside the tile is heavily weighted and the exact travel cost calculation within the tile is only lightly weighted, a calculation front that propagates in a rather linear fashion is obtained, wherein this calculated line propagates from one route endpoint to the other route endpoint in a largely linear fashion. In order to suitably adapt the inventive routing method between these two extremes, it is particularly advantageous to provide a first and a second correction value in the combined evaluation module, wherein the exactly calculated travel costs within the tile are multiplied with the first correction value and the estimated travel costs outside the tile are multiplied with the second correction value during the combined evaluation. Depending on the relation between the first correction value and the second correction value, the weighting of the travel cost calculation within the tile therefore can be adjusted relative to the travel cost estimation outside the tile.

It would be conceivable to specify a fixed first correction value and a fixed second correction value and to carry out all route calculation methods with the very same specified values. In this case, the first correction value and the second correction value need to be chosen in such a way that they represent a suitable compromise solution between the extremes. In comparison, it is particularly advantageous, however, if the first correction value and the second correction value can be variably changed in dependence on a route parameter. It is particularly advantageous if the first correction value and the second correction value can be changed in dependence on the distance between the two route endpoints. It has been determined that a rather linear propagation of the route calculation front is advantageous in the calculation of very long routes, on which the two route endpoints are spaced apart by a great distance covering a plurality of tiles, while a circular propagation of the route calculation front leads to the best results in the calculation of relatively short routes, in which the two route endpoints are spaced apart by a short distance. For example, when calculating a route from the North Cape to Gibraltar, the travel cost estimation outside the tile should be heavily weighted in the combined evaluation while the exact travel cost calculation within the tile should only have a relatively low significance with respect to the selection of the search direction. However, when calculating a local route, for example, in an inner city region, the exact travel cost calculation should be heavily weighted in the combined evaluation.

During the calculation of a route by means of the inventive routing method, the calculation steps a) to f) regularly need to be repeated very frequently in order to find a suitable route. At the end of each calculation loop, the respectively next tile, in which the route calculation is continued, needs to be selected in step e) of the routing method. In order to be able to find suitable routes as quickly and as effectively as possible, it is particularly advantageous to respectively select the directly adjacent tile that shares the boundary element with the best combined evaluation with the current tile for the continuation of the routing method. In other words, this means that, after a combined evaluation has respectively been carried out for all boundary elements of a tile, the resulting combined evaluations are compared with one another and the directly adjacent tile that shares the boundary element with the best combined evaluation with the current tile is subsequently selected for the next calculation step. Exactly this boundary element with the best combined evaluation is then set as starting point in step a) of the next calculation step in order to ultimately obtain an uninterrupted route.

If only the tiles that are situated directly adjacent to the tile for which the last calculation step was carried out are taken into account in the inventive routing method, specifically during the selection of the respectively next tile for carrying out the next calculation step with the steps a) to f), this can lead to the route calculation front reaching a dead end or not finding the most suitable route. For example, if a certain search direction was initially chosen based on a very good travel cost estimation and the route in this direction ends, however, in front of a lake, a mountain or another impassable obstacle, the route calculation method should be able to return to points that lie farther back and for which a calculation was already carried out. This return to already processed points can be achieved by keeping a control list. In this control list, a storage area with two storage spaces is generated for each boundary line of a tile that was already processed during the route calculation by carrying out a combined evaluation. A control dataset can be stored in each of these two storage spaces such that two control datasets are respectively assigned to one boundary line. In this case, the first control dataset respectively describes the best combined evaluation determined during the cross-over of the boundary line in one direction and the boundary element assigned to this combined evaluation. The second control dataset contains the boundary element that resulted in the best combined evaluation in the opposite direction.

Alternatively, the control list can also be stored in a more compact fashion and therefore such that it can be searched faster by merely storing the best combined evaluation for each tile—rather than for each tile boundary line.

Consequently, the control list represents the memory of the route calculation, in which the respective boundary elements with the best combined evaluations on a boundary line are stored. After carrying out each calculation loop with the steps a) to f), the control list is expanded by the resulting boundary elements that respectively have the best combined evaluations on the individual boundary lines. If such control lists are kept, not only the tiles situated directly adjacent to the current tile are taken into account for selecting the respectively next tile for the continuation of the route calculation method, but rather all tiles that are defined by the boundary elements stored in the control list. In this case, the respectively next tile can be selected by searching the control list for the boundary element that respectively has the best combined evaluation after the dynamic updating of the control list. In this case, the respective cross-over direction between the respectively adjacent tiles defined by the control datasets needs to be observed. Exactly this boundary element with the currently best combined evaluation in the control list is used as starting point in step a) of the next calculation step. Due to these measures, the route calculation method respectively returns to the point of the calculated path that has the best combined evaluation in the control list. This makes it possible to preclude a dead end during the propagation of the route calculation front.

If a control list is kept for carrying out the inventive routing method, this control list respectively needs to be dynamically updated. The updating of the control list needs to be based on the boundary lines between the tiles in this case. The dynamic updating of the control list should preferably take place after the combined evaluation was carried out for all boundary elements of the currently observed tile. If it is determined that a control dataset with a boundary element stored therein and the corresponding combined evaluation does not yet exist for a boundary line of the current tile, a new control dataset for this boundary line is generated and the current combined evaluation with the assigned boundary element is stored therein. However, if a control dataset already exists for a boundary line, for example, because the corresponding tile was already crossed over once during the course of the route calculation method, the existing control dataset needs to be checked with respect to the fact whether or not it needs to be updated. For this purpose, the current combined evaluation is compared with the combined evaluation that is already stored in the control dataset. If the current combined evaluation is superior to the combined evaluation that is already stored in the control dataset, the data stored in the control dataset is overwritten with the current boundary element and the current combined evaluation. However, if the current combined evaluation is not superior to the stored combined evaluation, the data stored in the control dataset remains unchanged.

In order to prevent endless iteration loops, the control dataset, the boundary element of which was already selected for the continuation of the route calculation method in one of the preceding calculation steps, should be deleted from the control list. This prevents the route calculation method from returning to this boundary element anew and once again continuing the route calculation at the same location.

With respect to carrying out the method effectively with the aid of the control list, it is advantageous to only store in the control list such control datasets that lead to a probable improvement of the route finding result. This is particularly important in instances, in which a first possible route between the two route endpoints has been found, but a search for alternative routes, if applicable, with lower travel costs should also be carried out. According to one preferred variation of the method, it is therefore proposed that, after finding a first route or after subsequently finding alternative routes between the two route endpoints, new control datasets respectively are only incorporated into the control list if the combined evaluation of the new control dataset is superior to a certain threshold value. This prevents a search for other alternative routes that apparently cannot result in any superior alternative routes.

The threshold value itself should be dynamically derived from the combined evaluation of the first route or from the combined evaluation of one of the last alternative routes between the two route endpoints.

In addition to preventing the storage of new control datasets that apparently can no longer result in superior routes, it is also particularly advantageous to delete all control datasets, the combined evaluation of which is inferior to the threshold value, from the control list. This is proposed because a promising continuation of the route calculation method can no longer be expected for all boundary elements in these control datasets in light of the fact that the combined evaluation is inferior to the threshold value.

In order to prevent that certain route alternatives are excluded from being incorporated into the control list early or are deleted from the control list early, the threshold value can be derived in the form of the product of the combined evaluation and a safety factor. In this case, the safety factor should have a value higher than 1.

When using a control list, a suitable abort condition for aborting the inventive method is the complete emptying of the control list. As soon as the control list no longer contains any boundary elements that could serve as suitable starting points for the further search, it is no longer sensible to search for other route alternatives. In this case, the fulfillment of this abort condition is significantly accelerated due to the fact that, when using a threshold value, all control datasets that are inferior to the threshold value are deleted from the control list and new control datasets are only generated if the corresponding combined evaluation of the boundary element is superior to the threshold value.

In its basic form, the routing method is used for driving the route calculation from one route endpoint in the direction of the other route endpoint until the route calculation front that originates from the first route endpoint passes over the second route endpoint. In order to additionally accelerate the calculating time for the calculation of at least one route between the two route endpoints, it is particularly advantageous, however, if the route calculation is carried out in two route search directions that begin at the first route endpoint and at the second route endpoint. In other words, this means that the search for a suitable route begins simultaneously from two route endpoints such that two route calculation fronts propagate from the two route endpoints. As soon as the two route calculation fronts propagating, for example, in an ellipsoidal fashion intersect, this results in at least one conceivable route between the two route endpoints.

With respect to the abort condition for aborting a search that originates from both route endpoints, it is particularly advantageous to respectively check if both route calculations in both search directions have respectively found a corresponding road. The two partial routes then merge in this corresponding road.

If the search is simultaneously carried out in two search directions originating from the two route endpoints, it is particularly advantageous if the classification of the significance of the roads, on which a boundary element is located, particularly the classification of the road as an expressway, a highway or a country road, is also taken into account in an evaluative fashion in the combined evaluation module. This is based on the notion that only roads of higher quality, particularly expressways, are used as the respective distance from the starting point or the destination increases, i.e., with increasing distance from the two route endpoints. It is therefore no longer sensible to search this area for less important roads such as, for example, smaller country roads intersecting the expressway in order to find suitable alternative routes.

When carrying out the route calculation in two search directions, it is naturally possible to respectively keep a control list for both search directions in order to select the next respective tile for the next respective calculation step. In this case, the abort condition needs to be modified in such a way that the calculation is aborted when one of the two control lists is empty and not a single route with a corresponding road has been determined yet. In this case, it can be assumed that one of the two route endpoints is an isolated location in the road network that cannot be reached via the roads of the road network. This early detection of isolated route endpoints is a significant advantage of the simultaneous search originating from both route endpoints because this result could otherwise only be detected after calculating a plurality of tiles.

If the abort condition has been fulfilled due to an empty control list, an error message informing the user of an isolated route endpoint should be output.

The tiles essentially may have any data structure. According to one preferred variation, the tiles respectively cover the same surface of the road map.

It is also particularly advantageous if the tiles respectively have the same shape, particularly a rectangular shape. With respect to the exact travel cost calculation within the tiles, a standard travel cost calculation algorithm may be used, particularly the routing algorithm according to Djikstra or the routing algorithm according to Belmann-Ford.

The travel cost estimation in the distance evaluation module can also be carried out in different ways. This estimation can be realized in a particularly fast and effective fashion if the straight line between the respective boundary element to be observed and the route endpoint is used as the distance for the estimation in the distance evaluation module.

The so-called “A-Star-Algorithm” has proved to be a suitable calculation method for estimating the travel costs in the distance evaluation module.

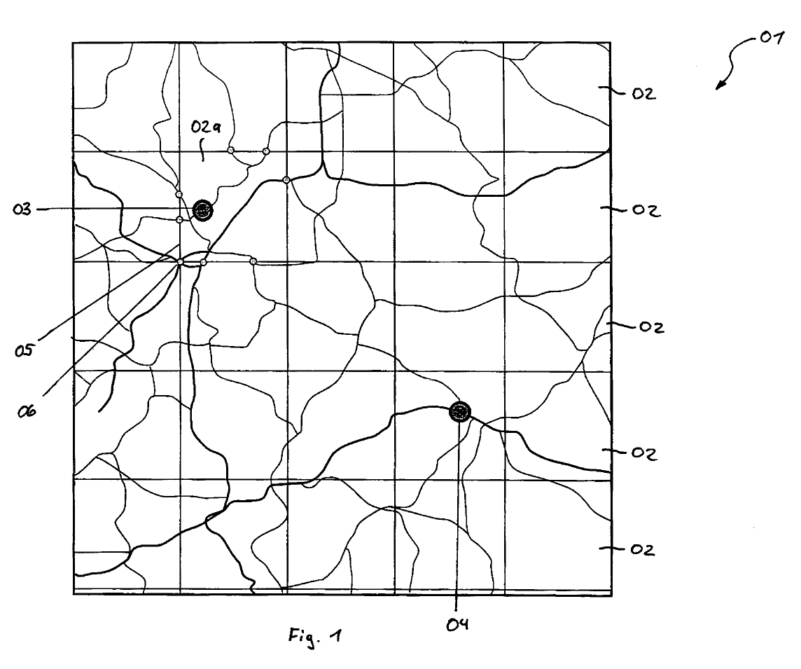

FIG. 1 schematically shows the road network in a geographic area 01. The geographic area 01 is divided into 25 tiles 02 that are respectively stored in a database in the form of separate groups of datasets. The inventive routing method is described in an exemplary fashion below based on the calculation of a route between a first route endpoint 03 and a second route endpoint 04.

For the first calculation step of the inventive routing method, the tile 02a that contains the route endpoint 03 such as, for example, the desired starting point of the route is initially defined. The tile 02a has four boundary lines 05 referred to its directly adjacent tiles 02, wherein the road network merges from the tile 02a into the adjacent tiles 02 at the boundary elements 06.

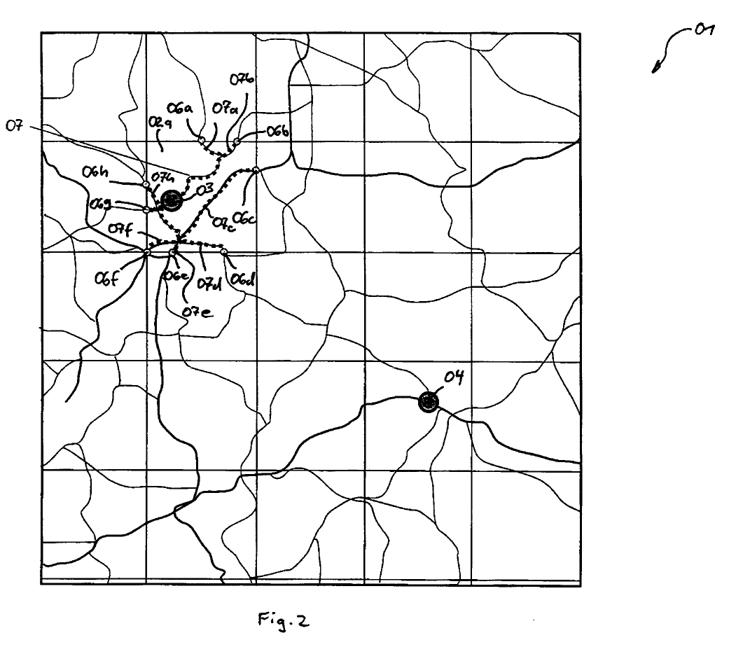

According to FIG. 2, a route 07a to 07h to the individual boundary elements 06a to 06h that is illustrated in the form of a dot-dash line is subsequently calculated for each of the boundary elements 06a to 06h within the tile 02a by means of a suitable route calculation method. The exact travel costs are calculated for each of these alternative routes 07a to 07h.

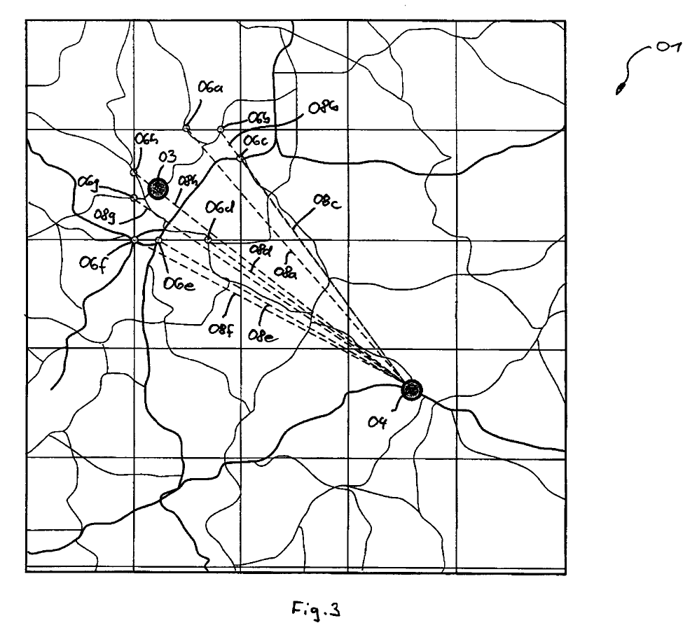

Subsequently, the travel costs for each boundary element 06 are estimated based on the straight line 08 between the boundary elements of the tile 02a and the second route endpoint 04, as is schematically illustrated in FIG. 3. The first intermediate result determined in accordance with FIG. 2, namely the exact travel costs within the tile, and the second intermediate result determined in accordance with FIG. 3, namely the estimated travel costs outside the tile, are subsequently evaluated in a combined evaluation module.

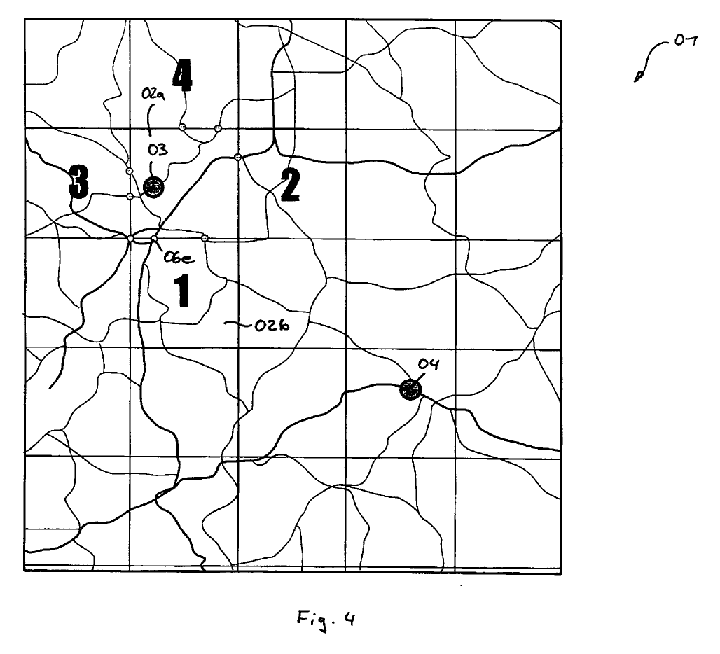

According to FIG. 4, this results, for example, in the boundary element 06e having the best combined evaluation such that the route calculation is subsequently continued with the tile 02b and the boundary element 06e as starting point. The combined evaluation of the boundary elements 06 with the respectively best evaluation on the other boundary lines 05 is intermediately stored in a control list. Subsequently, the above-described procedure is continued until the route calculation front that propagates in an ellipsoidal fashion has passed over the second route endpoint 04.

The above method is preferably performed by a GPS navigation device having a central processing unit, an input device, such as a touch screen or microphone for use by a user to input route endpoints, a display for displaying a calculated route, and memory for storing data, such as the electronically stored road map and control lists. The central processing unit performs the steps of the above method to determine a route between the endpoints, as disclosed above, and then displays the route on the navigation device display and/or provides audible directions via a speaker to the user to follow the route.

While there has been shown and described what are at present considered the preferred embodiment of the invention, it will be obvious to those skilled in the art that various changes and modifications can be made therein without departing from the scope of the invention defined by the appended claims. Therefore, various alternatives and embodiments are contemplated as being within the scope of the following claims particularly pointing out and distinctly claiming the subject matter regarded as the invention.

1. A routing method for calculating a route between a first route endpoint (03), particularly a starting point, and a second route endpoint (04), particularly a destination, by utilizing an electronically stored road map that describes the road network of a certain geographic area (01) consisting of roads and intersections by means of datasets stored in a database, wherein the road map is divided into several sections, namely tiles (02), that are stored in the database in the form of individual groups of datasets, wherein the tiles (02) collectively form the complete road map, and wherein the road network merges in boundary elements (06) particularly boundary roads, boundary intersections and/or boundary points, on the boundary lines (05) between adjacent tiles (02), with said method comprising the following steps:
a) defining a starting point (03) on a tile (02a);
b) calculating the travel cost value for all routes from the starting point (03) to all boundary elements (06) of the tile (02a) with a route calculation module, wherein the travel costs between the starting point (03) and each boundary element (06) are exactly determined during the travel cost calculation;
c) calculating a travel cost estimation for all boundary elements (06) of the tile (02a) with a distance evaluation module, wherein the travel costs from a boundary element (06) of the tile (02a) to one of the two route endpoints (04) are evaluated in an estimative fashion during the travel cost estimation based on the distance between the boundary element (06) and the route endpoint (04);
d) determining a combined value for all boundary elements (06) of the tile (02a) in a combined evaluation module, wherein the exactly calculated travel costs within the tile (02a) and the estimated travel costs outside the tile (02b) are evaluated in a combined fashion during the combined evaluation;
e) determining the next tile (02b) for continuing the route calculation in dependence on the combined evaluation; and
f) repeating steps a) to e) until an abort condition is fulfilled.

2. The routing method according to claim 1, in which a first route endpoint (03) is set as starting point in step a) at the beginning of the route calculation.

3. The routing method according to claim 1, in which the abort condition is fulfilled once at least one route between the two route endpoints has been determined.

4. The routing method according to claim 1, in which the exactly calculated travel costs within the tile (02a) are multiplied with a first correction value and/or the estimated travel costs outside the tile (02a) are multiplied with a second correction value during the determination of the combination value for the boundary elements (06) of the tile (02a) in the combined evaluation module.

5. The routing method according to claim 4, in which the first correction value and/or the second correction value can be changed in dependence on a route parameter, particularly in dependence on the distance between the two route endpoints (03, 04).

6. The routing method according to claim 1, in which the route calculation is continued in step e) with the next directly adjacent tile (02b), whose boundary line (05) with the preceding tile (02a) contains the boundary element (06e) with the best combined evaluation, wherein the boundary element (06e) with the best combined evaluation is set as starting point in step a) of the next calculation step.

7. The routing method according to claim 1, in which an ordered control list is kept, in which two control datasets can be stored for each boundary line (05) between a tile (02) that has already been processed during the route calculation and a directly adjacent tile (02), wherein the first control dataset contains the best combined evaluation determined for the cross-over at the boundary line (05) in one direction, as well as the assigned boundary element (06), and the second control dataset contains the best combined evaluation determined for the cross-over at the boundary line (05) in the opposite direction, as well as the assigned boundary element (06), wherein the route calculation is continued in step e) with the next tile (02), whose boundary line (05) has the control dataset with the best combined evaluation in the control list, and wherein the boundary element (06) stored in this control dataset is set as starting point in step a) of the next calculation step.

8. The routing method according to claim 7, in which, after calculating the combined evaluation in step d), it is respectively checked if a control dataset for this boundary line (05) already exists in the control list, wherein
aa) a new control dataset is generated if no control dataset exists for this boundary line (05) and the current combined evaluation and the assigned boundary element (06) are stored in this new control dataset;
bb) it is respectively checked whether or not the current combined evaluation is superior to the combined evaluation that is already stored in the control dataset if a control dataset already exists for this boundary line (05), wherein the combined evaluation stored in the control dataset and the assigned boundary element (06) are overwritten with the current combined evaluation and the assigned boundary element (06) in this case.

9. The routing method according to claim 7, in which the control dataset, in which the starting point for the next calculation step is stored in step a), is deleted from the control list.

10. The routing method according to claim 7, in which, after finding a first route or subsequent alternative route between the two route endpoints (03, 04), new control datasets are only incorporated into the control list if the combined evaluation of the new control dataset is superior to a threshold value.

11. The routing method according to claim 10, in which the threshold value is dynamically derived from the combined evaluation of the first route or from the combined evaluation of the last alternative route between the two route endpoints.

12. The routing method according to claim 10, in which all existing control datasets, the combined evaluation of which is inferior to the threshold value, are deleted from the control list.

13. The routing method according to claim 10, in which the threshold value is derived in the form of the product of the combined evaluation and a safety factor, wherein the safety factor has a value higher than 1.

14. The routing method according to claim 7, in which, after finding at least one route between the two route endpoints (03, 04), the route calculation for finding alternative routes is not aborted until the control list is empty.

15. The routing method according to claim 1, in which the route calculation is carried out in two search directions from the first route endpoint (03), as well as from the second route endpoint (04).

16. The routing method according to claim 15, in which the abort condition is fulfilled when at least one corresponding road is determined that has been selected in step e) during both route calculations from both search directions.

17. The routing method according to claim 15, in which, during the route calculation in two search directions, the classification of the significance of the road on which a boundary element is located, particularly the classification of the road as an expressway, a highway or a country road, is taken into account in the combined evaluation of the combined evaluation module in addition to the exactly calculated travel costs within a tile (02) and the estimated travel costs outside the tile (02).

18. The routing method according to claim 17, in which boundary elements (06) with the relatively highest road classification are preferably selected.

19. The routing method according to claim 15, in which, during the route calculation in two search directions, the abort condition is fulfilled when one of the two control lists that are respectively kept for both search directions is empty.

20. The routing method according to claim 15, in which an error message indicating an isolated route endpoint is output if the abort condition is fulfilled due to an empty control list.

21. The routing method according to claim 1, in which the tiles (02) respectively cover the same surface of the road map.

22. The routing method according to claim 1, in which the tiles (02) respectively have the same shape, particularly a rectangular shape.

23. The routing method according to claim 1, in which a standard travel cost calculation algorithm, particularly the routing algorithm according to Djikstra or the routing algorithm according to Belmann-Ford, is used in the route calculation module for calculating the exact travel costs within the tile (02).

24. The routing method according to claim 1, in which the distance between a boundary element (06) and the route endpoint (04) is determined along a straight line in the distance evaluation module and this distance along the straight line forms the basis for the travel cost estimation.

25. The routing method according to claim 1, in which the A-Star-Algorithm is used for estimating the travel costs in the distance evaluation module.
